(19) United States
(12) Patent Application Publication
(10) Pub. No.: US 2016/0140399 A1
(43) Pub. Date: May 19, 2016

(54) OBJECT DETECTION APPARATUS AND METHOD THEREFOR, AND IMAGE RECOGNITION APPARATUS AND METHOD THEREFOR

(71) Applicant: CANON KABUSHIKI KAISHA, Tokyo (JP)

(72) Inventors: Kotaro Yano, Tokyo (JP); Ichiro Umeda, Tokyo (JP)

(21) Appl. No.: 14/941,360

(22) Filed: Nov. 13, 2015

(30) Foreign Application Priority Data
Nov. 17, 2014 (JP) 2014-233135

(51) Int. Cl. G06K 9/00; G06T 7/00; G06K 9/32

(52) U.S. Cl. CPC G06K 9/00778; G06K 9/3241; G06T 7/0051; G06K 9/00228; G06T 2207/10024

(57) ABSTRACT

An object detection apparatus includes an extraction unit configured to extract a plurality of partial areas from an acquired image, a distance acquisition unit configured to acquire a distance from a viewpoint for each pixel in the extracted partial area, an identification unit configured to identify whether the partial area includes a predetermined object, a determination unit configured to determine, among the partial areas identified to include the predetermined object by the identification unit, whether to integrate identification results of a plurality of partial areas that overlap each other based on the distances of the pixels in the overlapping partial area, and an integration unit configured to integrate the identification results of the plurality of partial areas determined to be integrated to detect a detection target object from the integrated identification result of the plurality of partial areas.

### BACKGROUND OF THE INVENTION

1. Field of the Invention

The present invention relates to an object detection apparatus for detecting a predetermined object from an input image and a method therefor, and to an image recognition apparatus and a method therefor.

2. Description of the Related Art

In digital still cameras and camcorders, a function of detecting a face of a person from an image while being captured and a function of tracking the person have been rapidly and widely spread in recent years. Such a facial detection function and a human tracking function are extremely useful to automatically focus a target object to be captured and to adjust exposure thereof. For example, there is a technique that is discussed in non-patent document entitled “Rapid Object Detection using Boosted Cascade of Simple Features”, by Viola and Jones, Proceedings of the 2001 IEEE Computer Society Conference on Computer Vision and Pattern Recognition, 2001 (hereinafter, referred to as non-patent document 1). The use of such a technique has advanced the practical application of the detection of a face from an image.

Meanwhile, there are demands for the use of monitoring cameras not only for detecting a person based on a face thereof in a state where the face of the person is seen, but also for detecting a person in a state where a face of the person is not seen. Results of such detection can be used for intrusion detection, surveillance of behavior, and monitoring of congestion level.

A technique for enabling a person to be detected in a state where a face of the person is not seen is discussed, for example, in non-patent document entitled “Histograms of Oriented Gradients for Human Detection”, by Dalal and Triggs, IEEE Computer Society Conference on Computer Vision and Pattern Recognition, 2005 (hereinafter, referred to as non-patent document 2). According to the method discussed in non-patent document 2, a histogram of gradient directions of pixel values is extracted from an image, and the extracted histogram is used as a feature amount (histogram of oriented gradients (HOG) feature amount) to determine whether a partial area in the image includes a person. Thus, an outline of a human body is expressed by the feature amounts, which are the gradient directions of the pixel values, and is used for not only human detection but also recognition of a specific person.

In such human detection, however, if a person in an image is partially occluded by other objects, accuracy in detecting the person from the image is degraded. This causes degradation of accuracy in recognizing a specific person. Such a state often occurs when an input image includes a crowd of persons. In such a case, for example, the number of persons in the crowd cannot be accurately counted.

Thus, there is a method for dealing with the case in which a body of a person is partially occluded by shadow of other objects. Such a method is discussed, for example, in non-patent document entitled “A discriminatively trained, multiscale, deformable part model”, by Felzenszwalb et al., IEEE Conference on Computer Vision and Pattern Recognition, 2008 (hereinafter, referred to as non-patent document 3). As discussed in non-patent document 3, the method divides a person in an image into parts such as a head, arms, legs, and a body, and detects each of the divided parts. Then, the method integrates the detection results. Further, non-patent document entitled “Handling occlusions with franken-classifiers”, by Mathias et al., IEEE International Conference on Computer Vision, 2013 (hereinafter, referred to as non-patent document 4) discusses a method using a human detector. In such a method, a plurality of human detectors in which different occluded parts are assumed beforehand is prepared, and a human detector with a high response result among the plurality of human detectors is used. Meanwhile, non-patent document entitled “An HOG-LBP Human Detector with Partial Occlusion Handling”, by Wang et al., IEEE 12th International Conference on Computer Vision, 2009 (hereinafter, referred to as non-patent document 5) discusses a method by which an occluded area of a person is estimated from a feature amount acquired from an image, and human detection processing is performed according to the estimation result.

Further, there are methods for enhancing human detection in an image by using a range image in addition to a red-green-blue (RGB) image. The range image has a value of a distance from an image input apparatus such as a camera to a target object. The range image is used instead of or in addition to a color value and a density value of the RGB image. These methods handle the range image by using a detection method similar to that for the RGB image, and extract a feature amount from the range image as similar to the RGB image. Such an extracted feature amount is used for human detection and recognition. For example, in Japanese Patent Application Laid-Open No. 2010-165183, a gradient of a range image is determined, and human detection is performed using the determined gradient as a distance gradient feature amount.

However, in a case where human detection is to be performed by using the method as discussed in non-patent document 3 or 4, an amount of calculation for human detection remarkably increases. With the technique discussed in non-patent document 3, detection processing needs to be performed for each part of a person. With the technique discussed in non-patent document 4, processing needs to be performed using a plurality of human detectors in which different occluded parts are assumed. Therefore, numerous processes need to be activated or a plurality of detectors needs to be provided to deal with the increased amount of calculation processing. This complicates a configuration of the detection apparatus, and thus the detection apparatus needs a processor that can withstand a higher processing load. Further, as for the occluded area estimation method discussed in non-patent document 5, estimation of the occluded area is difficult to be performed with high accuracy, and human detection accuracy depends on a result of the estimation. Accordingly, in a case where persons are detected in a crowded state, for example, potential detection target persons overlap each other in an image, appropriate identification of the detection target persons (objects) in the image is conventionally difficult in consideration of a state in which a person in the image is partially occluded by other objects.

However, even in a case where persons are detected in a crowded state, human detection can be performed in each area. In such a case, conventionally, if the areas (partial areas) in which persons are detected overlap, these areas are equally integrated into one area at identification of the detected persons. As a result, this causes misdetection or detection failure, for example, the number of persons that can be detected is less than the actual number of persons. In many cases, a human detector usually outputs a plurality of detection results with respect to one person, and physically overlapping areas are integrated as one area (i.e., a plurality of detection results is assumed to be outputs from one person, and these results are integrated). However, in the actual crowded state, a plurality of persons often overlaps in an image. The equal integration of the areas causes the plurality of persons to be identified as the same person (one person) although these persons should be identified as a plurality of different persons. Consequently, the number of persons as detection targets can be miscounted.

### SUMMARY OF THE INVENTION

The present invention relates to a technique capable of detecting an object with high accuracy even from an input image in which a crowded state is captured, for example, objects of potential detection targets overlap each other in the image.

According to an aspect of the present invention, an object detection apparatus includes an extraction unit configured to extract a plurality of partial areas from an acquired image, a distance acquisition unit configured to acquire a distance from a viewpoint for each pixel in the extracted partial area, an identification unit configured to identify whether the partial area includes a predetermined object, a determination unit configured to determine, among the partial areas identified to include the predetermined object by the identification unit, whether to integrate identification results of a plurality of partial areas that overlap each other based on the distances of the pixels in the overlapping partial areas, and an integration unit configured to integrate the identification results of the plurality of partial areas determined to be integrated to detect a detection target object from the integrated identification result of the plurality of partial areas.

Further features of the present invention will become apparent from the following description of exemplary embodiments with reference to the attached drawings.

### BRIEF DESCRIPTION OF THE DRAWINGS

FIG. 1 is a block diagram illustrating an example configuration of an object detection apparatus according to an exemplary embodiment of the present invention.

FIG. 2 is a block diagram illustrating an example of a configuration of a human body identification unit.

FIG. 3 is a block diagram illustrating an example configuration of an area integration unit.

FIG. 4 is a flowchart illustrating object detection processing according to an exemplary embodiment.

FIG. 5 is a flowchart illustrating object identification processing in detail.

FIG. 6 is a diagram illustrating an example of image data to be input.

FIG. 7 is a diagram illustrating an example of a partial area image to be extracted from the input image.

FIG. 8 is a diagram illustrating an example of an image in which a plurality of persons overlaps as another example of the partial area image to be extracted from the input image.

FIG. 9 is a diagram illustrating an example of a range image.

FIG. 10 is a diagram illustrating an example of a feature vector.

FIG. 11 is a flowchart illustrating area integration processing in detail.

FIG. 12 is a diagram illustrating an example of a human detection result.

FIG. 13 is a diagram illustrating another example of the range image.

FIG. 14 is a diagram illustrating an example hardware configuration of a computer of the object detection apparatus.

### DESCRIPTION OF THE EMBODIMENTS

Exemplary embodiments of the present invention are described in detail below with reference to the drawings.

Each of the following exemplary embodiments is an example of the present invention, and configurations of an apparatus to which the present invention is applied may be modified or changed as appropriate according to various conditions. It is therefore to be understood that the present invention is not limited to the exemplary embodiments described below.

The term “detection” used throughout the present specification represents determination whether a detection target object is present. For example, an object to be detected is a person in an image. In such a case, if a plurality of persons is present in the image, the number of persons in the image is determined without differentiating one individual from another. Such determination corresponds to the “detection”. On the other hand, the differentiation of one individual from another in the image (e.g., a specific person (Mr. A or Mr. B) is differentiated) is generally referred to as “recognition” of an object. Similarly, these concepts can be applied even if a detection target is an object (e.g., an optional object such as an animal, a car, and a building) other than a person.

### <Configuration of Object Detection Apparatus>

Hereinbelow, an exemplary embodiment of the present invention is described using an example case in which an object to be detected from an image is a person, and a portion including a head and shoulders of a person is detected as a human body. However, a detection target object to which the present exemplary embodiment can be applied is not limited to a person (a human body). The exemplary embodiment may be applied to any other subjects by adapting a pattern collation model (described below) to a target object.

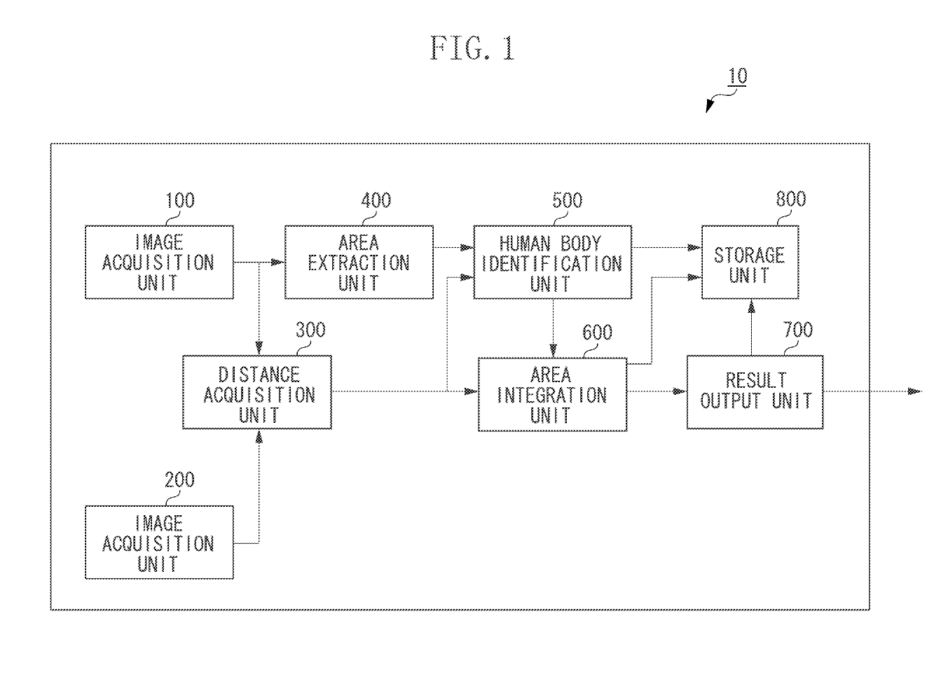

FIG. 1 is a block diagram illustrating an example configuration of an object detection apparatus 10 according to the present exemplary embodiment of the present invention. As illustrated in FIG. 1, the object detection apparatus 10 includes image acquisition units 100 and 200, a distance acquisition unit 300, an area extraction unit 400, a human body identification unit 500, an area integration unit 600, a result output unit 700, and a storage unit 800.

Each of the image acquisition units 100 and 200 acquires image data captured by an image capturing unit such as a camera arranged outside, and supplies the acquired image data to the distance acquisition unit 300 and the area extraction unit 400. Alternatively, each of the image acquisition units 100 and 200 may be configured as an image capturing unit (an image input apparatus) such as a camera. In such a case, each of the image acquisition units 100 and 200 captures an image, and supplies image data to the distance acquisition unit 300 and the area extraction unit 400.

In FIG. 1, a plurality (two) of image acquisition units is disposed so that the distance acquisition unit 300 determines a distance of an image based on the stereo matching theory (described below) by using the image data acquired by each of the image acquisition units 100 and 200. However, for example, in a case where a distance is acquired by another method, only one image acquisition unit may be required. The image data acquired herein may be a red-green-blue (RGB) image, for example.

The distance acquisition unit 300 acquires a distance corresponding to each pixel in the image data acquired by the image acquisition unit 100 based on the image data acquired by each of the image acquisition units 100 and 200, and supplies the acquired distance to the human body identification unit 500 and the area integration unit 600.

The distance acquisition unit 300 acquires the distance. The term “distance” used herein represents a distance in a direction of depth of an object to be captured in an image (a direction perpendicular to an image), and is a distance from a viewpoint of an image capturing unit (an image input apparatus) such as a camera to a target object to be captured. Image data to which data of such a distance is provided with respect to each pixel in the image is referred to as “a range image”. The distance acquisition unit 300 may acquire the distance from the range image. The range image can be understood as an image that has a value of the distance as a value of each pixel (instead of brightness and color or with brightness and color). The distance acquisition unit 300 supplies such a value of the distance specified for each pixel to the human body identification unit 500 and the area integration unit 600. Further, the distance acquisition unit 300 can store the distance or the range image of the acquired image into an internal memory of the distance acquisition unit 300 or the storage unit 800.

The distance in the present exemplary embodiment may be a normalized distance. Thus, in a precise sense, a distance from (a viewpoint of) an image capturing apparatus needs to be actually measured in consideration of a focal length of an optical system of the image acquisition unit and a separation distance between the two image acquisition units apart from side to side. However, in the present exemplary embodiment, since a distance difference in a depth direction of a subject (a parallax difference) can be used for object detection, determination of the actual distance in a precise manner may not be needed.

The area extraction unit 400 sets a partial area in the image acquired by the image acquisition unit 100 or the image acquisition unit 200. This partial area is set in the acquired image. The partial area serves as a unit area (a detection area) used for determining whether the partial area is a person. Thus, determination is made with respect to each partial area whether the partial area includes an image of a person.

The area extraction unit 400 extracts image data of a partial area (hereinafter, referred to as “a partial area image”) that is set in the image data acquired by the image acquisition unit 100 (or the image acquisition unit 200). Such partial area setting is performed by thoroughly setting a plurality of (many) partial areas in the image data. Suitably, a certain partial area is set in a position where the certain partial area and other partial areas overlap to some extent. The partial area setting is described in detail below.

The human body identification unit 500 determines, with respect to each partial area, whether an image (a partial area image) in the partial area extracted by the area extraction unit 400 is a person. If the human body identification unit 500 determines that the partial area includes an image of a person, the human body identification unit 500 outputs a likelihood (hereinafter, referred to as a “score”) indicating how much the image looks like a person and position coordinates of the partial area image. The score and the position coordinates for each partial area may be stored in an internal memory of the human body identification unit 500 or the storage unit 800. In the present exemplary embodiment, when determining whether the image is a person, the human body identification unit 500 selectively calculates an image feature amount using the range image or the distance acquired by the distance acquisition unit 300. Such an operation will be described in detail below.

If a plurality of partial area images determined to be a person by the human body identification unit 500 overlaps, the area integration unit 600 integrates detection results (identification results). In other words, if the partial area images determined to be a person overlap on the certain position coordinates, the area integration unit 600 integrates the plurality of overlapping partial area images. Generally, one person can be identified and detected from the integrated partial area image. When determining whether to integrate the detection results, the area integration unit 600 uses the range image or the distance acquired by the distance acquisition unit 300. Such an operation will be described in detail below.

The result output unit 700 outputs a human body detection result that is integrated by the area integration unit 600. For example, the result output unit 700 may cause a rectangle indicating an outline of the partial area image determined to be a person to overlap the image data acquired by the image acquisition unit 100 or the image acquisition unit 200, and display the resultant rectangle on a display apparatus such as a display. As a result, the rectangle surrounding the person detected in the image is displayed. In this way, how many persons have been detected can be readily known.

The storage unit 800 stores data that is output from each of the image acquisition unit 100, the image acquisition unit 200, the distance acquisition unit 300, the area extraction unit 400, the human body identification unit 500, the area integration unit 600, and the result output unit 700 in an external storage apparatus or an inside storage apparatus as necessary.

The person in the image detected by the object detection apparatus 10 may be further recognized as a specific person in a subsequent stage.

### <Configuration of Human Body Identification Unit>

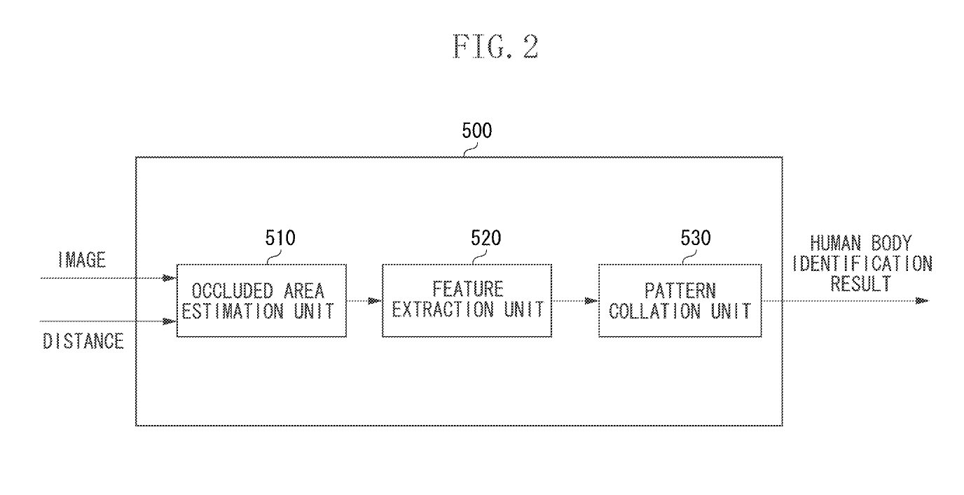

FIG. 2 is a diagram illustrating a detailed configuration of the human body identification unit 500 illustrated in FIG. 1. As illustrated in FIG. 2, the human body identification unit 500 according to the present exemplary embodiment includes an occluded area estimation unit 510, a feature extraction unit 520, and a pattern collation unit 530.

The occluded area estimation unit 510 receives a partial area image from the area extraction unit 400, and a distance from the distance acquisition unit 300. The occluded area estimation unit 510 estimates an occluded area in the partial area image extracted by the area extraction unit 400 to determine whether the partial area includes an image of a person. The term “occluded area” used herein represents an area that is not used in calculation of a local feature amount by the feature extraction unit 520 for human detection. For example, the occluded area may be an area of a detection target person who is occluded by a foreground object (e.g., a person) that overlaps the detection target person on the image. The occluded area estimation unit 510 uses the range image acquired by the distance acquisition unit 300 when estimating the occluded area. Thus, in the present exemplary embodiment, the occluded area estimation unit 510 estimates an occluded area based on the distance, and the estimated occluded area is not used for human detection.

The feature extraction unit 520 obtains a feature amount for human detection from an area excluding the occluded area estimated by the occluded area estimation unit 510. As described below, in the present exemplary embodiment, one partial area may be divided into a plurality of local blocks (e.g., 5×5 blocks, 7×7 blocks). Each of the local blocks may be classified as a local block for which a feature amount is calculated since it may correspond to a person, a local block that is not used for calculation of a feature amount since there is noise (e.g., foreground) although it may correspond to a person, or a local block that does not correspond to a person. The feature extraction unit 520, for example, may calculate a feature amount from only the local block for which a feature amount is determined since the local block corresponds to a person (hereinafter, a feature amount calculated for a local block is referred to as “a local feature amount”). At this stage, identification of a local block that looks like a person is enough for determination of whether the image is a person. Thus, the determination can be simply performed by using a shape and a shape model. The shape characterizes an outline shape of a person, and is, for example, an omega-type shape and a substantially inverted triangle shape. The shape model includes a symmetrical shape model such as a head, shoulders, a body, and legs.

Accordingly, with the occluded area estimation unit 510 and the feature extraction unit 520, an amount of feature amount calculation processing can be reduced, and human detection can be performed with higher accuracy.

The feature extraction unit 520 may calculate a feature amount by using the occluded area estimated by the occluded area estimation unit 510 and excluding a background area in the image. The feature extraction unit 520 may calculate a feature amount of only an outline of the area corresponding to a person. Alternatively, the feature extraction unit 520 may calculate a feature amount by a combination of these and the above processing as appropriate.

The pattern collation unit 530 determines whether the partial area image extracted by the area extraction unit 400 is a person based on the local feature amount determined by the feature extraction unit 520. The determination of human detection at this stage can be executed by pattern matching of a predetermined human model with a feature vector acquired by integration of the calculated local feature amounts.

### <Configuration of Area Integration Unit>

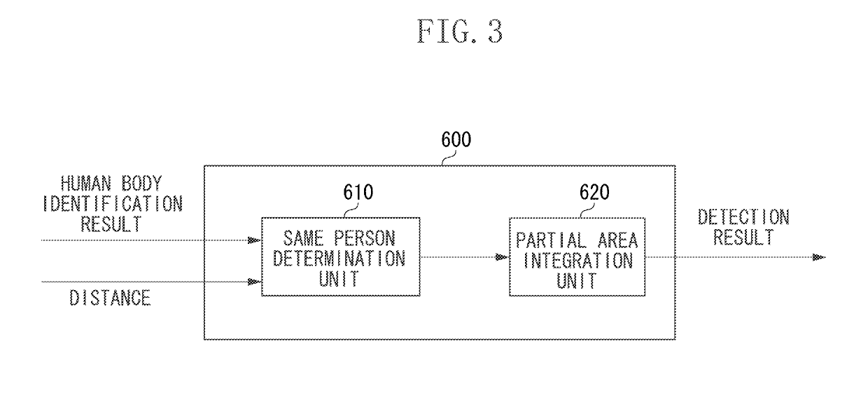

FIG. 3 is a block diagram illustrating a detailed configuration of the area integration unit 600 illustrated in FIG. 1. As illustrated in FIG. 3, the area integration unit 600 according to the present exemplary embodiment includes a same person determination unit 610 and a partial area integration unit 620. The same person determination unit 610 receives a human body identification result that is input from the human body identification unit 500, and a distance that is input from the distance acquisition unit 300. The same person determination unit 610 uses the distance to determine whether a plurality of partial area images overlapping each other is the same person. If the same person determination unit 610 determines these overlapping images are different persons, the same person determination unit 610 outputs a command signal to the partial area integration unit 620 so as not to integrate the partial areas including images of different persons.

The partial area integration unit 620, according to the signal input from the same person determination unit 610, integrates the plurality of overlapping partial areas excluding the partial areas determined to include the images of the different persons. Then, the partial area integration unit 620 outputs a human detection result acquired by the integration of the partial areas to the result output unit 700 and the storage unit 800.

Accordingly, with the same person determination unit 610 and the partial area integration unit 620, a plurality of different persons is effectively prevented from being identified as the same person, and detection failure and misdetection of persons can be reduced.

### <Object Detection Processing by Object Detection Apparatus>

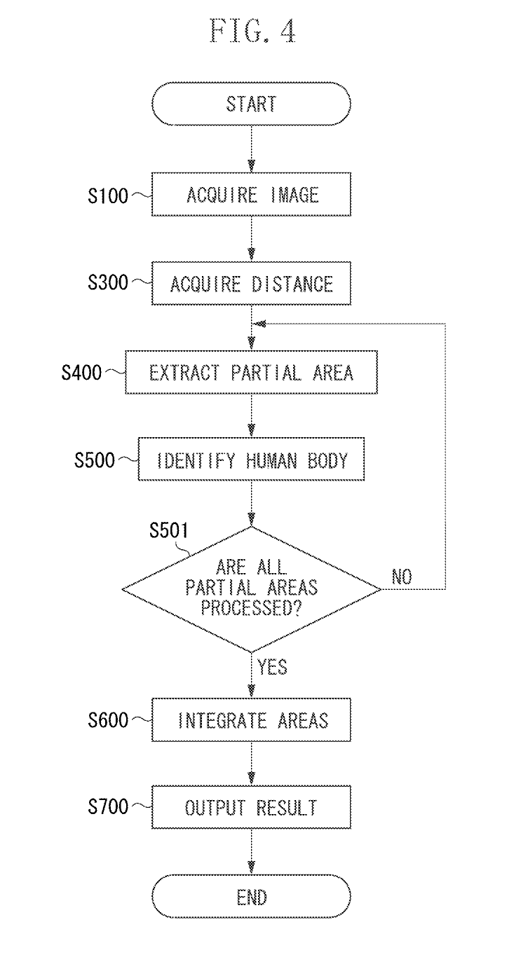

Hereinbelow, operations performed by the object detection apparatus 10 according to the present exemplary embodiment are described with reference to a flowchart illustrated in FIG. 4. In step S100, each of the image acquisition unit 100 and the image acquisition unit 200 acquires image data of a captured image. The acquired image data is stored in internal memories of the respective image acquisition units 100 and 200 or the storage unit 800.

In the present exemplary embodiment, when the images to be acquired by the image acquisition units 100 and 200 are captured, visual fields of the image capturing units are adjusted to substantially overlap each other. Further, the two image capturing units for capturing the two images to be input to the respective image acquisition units 100 and 200 may be arranged side by side with a predetermined distance apart. This enables a distance to be measured by stereoscopy, so that data of the distance (the range image) from a viewpoint of the image capturing unit to a target object can be acquired.

Further, each of the image acquisition units 100 and 200 can reduce the acquired image data to a desired image size. For example, reduction processing is performed for the predetermined number of times, for example, the acquired image data is reduced by 0.8 times and further reduced by 0.8 times (i.e., 0.8² times), and the reduced images having different scale factors are stored in an internal memory of the image acquisition unit 100 or the storage unit 800. Such processing is performed to detect each of the persons having different sizes from the acquired images.

In step S300, from the image data acquired by the image acquisition unit 100 and the image acquisition unit 200, the distance acquisition unit 300 acquires a distance corresponding to each pixel of the image data acquired by the image acquisition unit 100 (or the image acquisition unit 200, the same applies to the following).

In the present exemplary embodiment, the acquisition of distance data may be performed based on the stereo matching theory. More specifically, a pixel position of the image acquisition unit 200 corresponding to each pixel of the image data acquired by the image acquisition unit 100 may be obtained by pattern matching, and a difference in parallax thereof in two-dimensional distribution can be acquired as a range image.

The distance acquisition is not limited to such a method. For example, a pattern light projection method and a time-of-flight (TOF) method can be used. The pattern light projection method acquires a range image by projecting a coded pattern, whereas the TOF method measures a distance with a sensor based on a flight time of light. The acquired range image is stored in the internal memory of the distance acquisition unit 300 or the storage unit 800.

In step S400, the area extraction unit 400 sets a partial area in the image data acquired by the image acquisition unit 100 to extract a partial area image. The partial area is set for determining whether to include a person.

At this time, as for the image acquired by the image acquisition unit 100 and the plurality of reduced images, a position of a partial area having a predetermined size is sequentially shifted by a predetermined amount from an upper left edge to a lower right edge of the image to clip partial areas. In other words, partial areas are thoroughly set in the image so that objects in various positions and objects at various scale factors can be detected from the acquired image. For example, a clip position may be shifted in such a manner that 90% of length and breadth of the partial area overlap other partial areas.

In step S500, the human body identification unit 500 determines whether the partial area image extracted by the area extraction unit 400 is a human body (a person). If the human body identification unit 500 determines that the partial area image is a person, the human body identification unit 500 outputs a score indicating a likelihood thereof and position coordinates of the partial area image. Such human body identification processing will be described in detail below. In step S501, the object detection apparatus 10 determines whether all the partial areas are processed. The processing in step S400 and step S500 is sequentially repeated for each partial area in the image until all the partial areas are processed (YES in step S501).

In step S600, the area integration unit 600 integrates detection results if a plurality of partial area images determined to be a person by the human body identification unit 500 overlaps. This area integration processing will be described below. In step S700, the result output unit 700 outputs the human body identification result integrated by the area integration unit 600.

### <Human Body Identification Processing by Human Body Identification Unit>

Next, human body identification processing executed by the human body identification unit 500 is described in detail.

In step S510, the human body identification unit 500 acquires a reference distance of a partial area image as a human body identification processing target from the distance acquisition unit 300. In the present exemplary embodiment, the term “reference distance” of the partial area image represents a distance corresponding to a position serving as a reference in the partial area image.

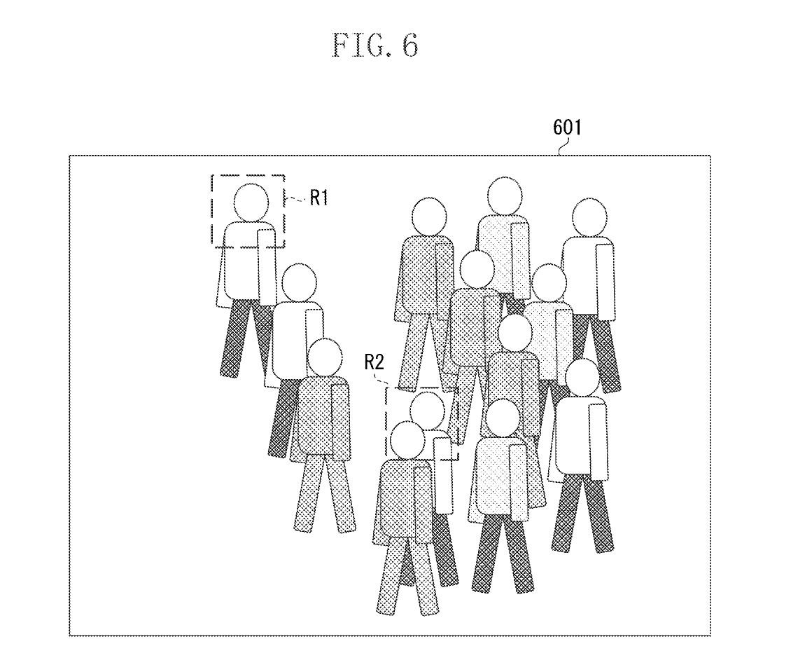

FIG. 6 is a diagram illustrating an example of image data acquired by the image acquisition unit 100. In FIG. 6, each of partial areas R1 and R2 may be rectangular, and only the partial areas R1 and R2 are illustrated. However, as described above, many partial areas can be arranged to overlap one another in vertical and horizontal directions to some extent, for example, approximately 90%. For example, a partial area group may be thoroughly set in image data while overlapping adjacent partial areas.

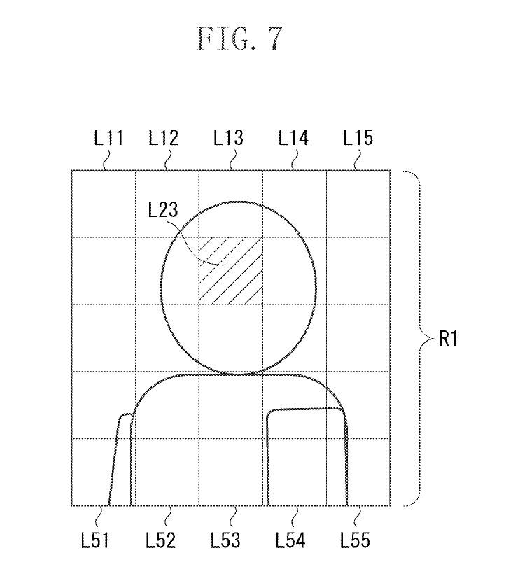

FIG. 7 is a diagram illustrating an example of a partial area image corresponding to the partial area R1 illustrated in FIG. 6. In FIG. 7, the partial area R1 is divided into local blocks, for example, a group of 5×5 local blocks (L11, L12, . . . , L54, and L55). However, the division of partial area into local blocks is not limited thereto. The partial area may be divided into segments on an optional unit basis.

In the partial area R1 illustrated in FIG. 7, a distance corresponding to a local block L23 of a shaded portion is set to the reference distance described above. For example, as illustrated in FIG. 7, a distance of a portion corresponding to a head of an object estimated as a human-like object can be set to a reference distance. As described above, in the present exemplary embodiment, since the model such as an omega-type shape is first used for detecting a head and shoulders from an area that seems to be a person, the partial area is set in such a manner that the head and the shoulder are at positions surrounded by the partial area. As illustrated in FIG. 7, a size of the local block for acquiring the reference distance can be set to correspond to that of the head. In a case where another object model is used, a size of the local block can be set according to the model.

Herein, the reference distance can be acquired by expression (1).

d0=1÷s0 (1)

where d0 is the reference distance.

In the expression (1), where s0 is a parallax difference of the local block L23 acquired from the distance acquisition unit 300, and is a value satisfying s0>0. The local block L23 is the shaded portion illustrated in FIG. 7. Alternatively, a value of s0 may be a representative parallax difference in the range image corresponding to the local block L23 of the shaded portion illustrated in FIG. 7. The representative parallax difference may be any of a parallax difference of the center pixel of the local block L23, and an average parallax difference of pixels inside the local block L23. However, the representative parallax difference is not limited thereto. The representative parallax difference may be a value determined by other statistical methods.

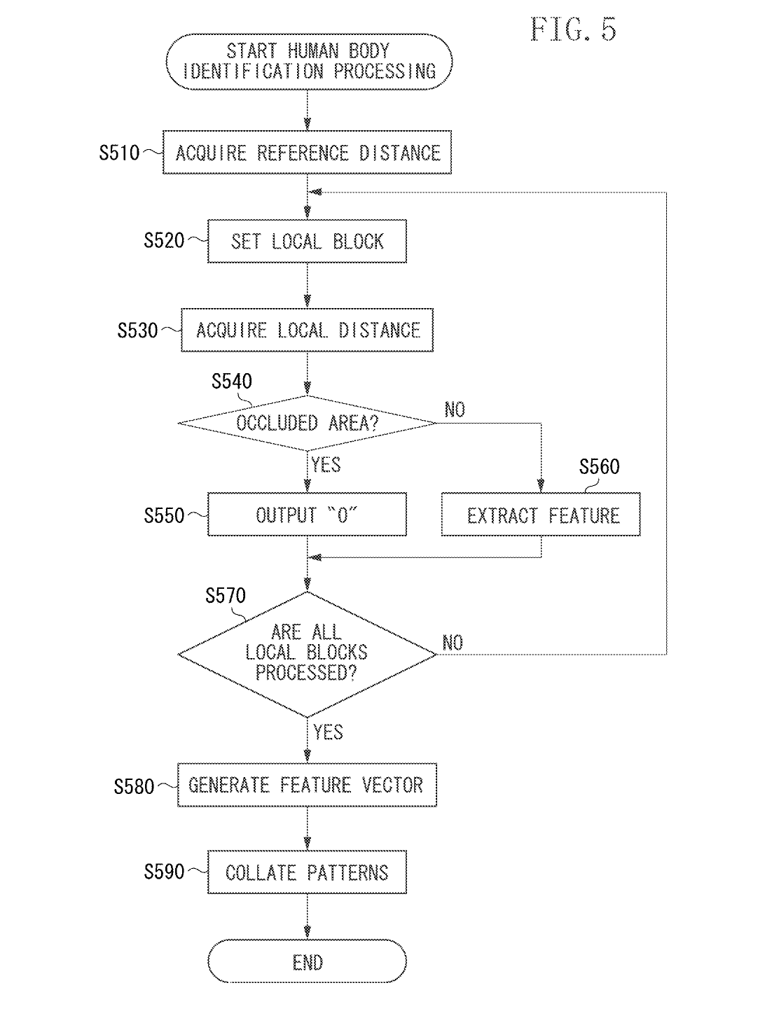

Referring back to FIG. 5, in step S520, the occluded area estimation unit 510 sets local blocks inside the acquired partial area image. The local block is a small area that is provided by dividing a partial area image into rectangular areas each having a predetermined size as illustrated in FIG. 7. In an example illustrated in FIG. 7, the partial area image is divided into 5×5 blocks. The partial area image may be divided so that the local blocks do not overlap one another as illustrated in FIG. 7, or the local blocks partially overlap one another. In FIG. 7, an upper left block L11 is first set, and the processing is sequentially repeated until a lower right block L55 is set.

Next, in step S530, a distance (hereinafter, referred to as “a local distance”) corresponding to the processing target local block set in step S520 is acquired from the distance acquisition unit 300. The acquisition of the local distance can be performed similarly to the processing performed in step S510.

In step S540, the occluded area estimation unit 510 compares the reference distance acquired in step S510 with the local distance acquired in step S530 to estimate whether the local block set in step S520 is an occluded area. Particularly, the occluded area estimation unit 510 determines whether expression (2) below is satisfied.

d0−d1>dT1, (2)

where d0 is a reference distance, and d1 is a local distance. If the expression (2) is satisfied, the occluded area estimation unit 510 determines that the local area of the processing target is an occluded area.

In the expression (2), dT1 is a predetermined threshold value. For example, if a detection target is a person, dT1 may be a value corresponding to an approximate thickness of a human body. As described above, since the distance in the present exemplary embodiment is a normalized distance, a value of dT1 may also correspond to a normalized human-body-thickness. If the occluded area estimation unit 510 determines that the local block is an occluded area (YES in step S540), the processing proceeds to step S550. In step S550, the feature extraction unit 520 outputs, for example, “0” instead of a value of a feature amount without performing feature extraction processing.

On the other hand, if the occluded area estimation unit 510 determines that the local block is not an occluded area (NO in step S540), the processing proceeds to step S560. In step S560, the feature extraction unit 520 extracts a feature from the local block. In such a feature extraction, for example, the feature extraction unit 520 can calculate the HOG feature amount discussed in non-patent document 2. For the local feature amount to be calculated at that time, a feature amount such as brightness, color, and edge intensity may be used other than the HOG feature amount, or a combination of these feature amounts and the HOG feature amount may be used.

In step S570, the processing from step S520 to step S560 is sequentially repeated for each local block in the image. After all the local blocks are processed (YES in step S570), the processing proceeds to step S580.

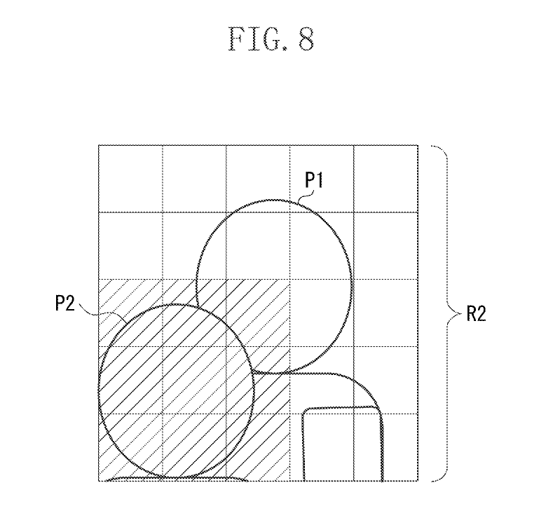

The occluded area estimation processing (selective local feature amount extraction processing) to be executed by the occluded area estimation unit 510 is described with reference to FIG. 8. A partial area image R2 illustrated in FIG. 8 corresponds to the partial area R2 in the image illustrated in FIG. 6. In the example illustrated in FIG. 8, a left shoulder of a background person P1 is occluded by a head of a foreground person P2. In such a case, a shaded block portion (3×3 blocks in the lower left portion) illustrated in FIG. 8 causes noise when the background person P1 is detected. This degrades human identification accuracy in pattern collation processing that is performed in a subsequent stage.

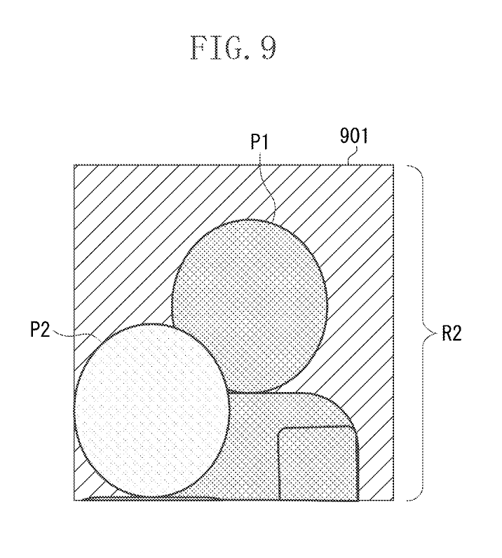

In the present exemplary embodiment, the use of the range image can reduce such degradation in identification accuracy. FIG. 9 is a diagram illustrating a depth map in which distances in a range image 901 corresponding to the partial area image in FIG. 8 are illustrated with shade. In FIG. 9, the darker the portion, the farther the distance. In step S540, comparison of distances between the local blocks in FIG. 9 can prevent extraction of a local feature amount from the shaded portion illustrated in FIG. 8, thereby suppressing degradation of human body identification accuracy.

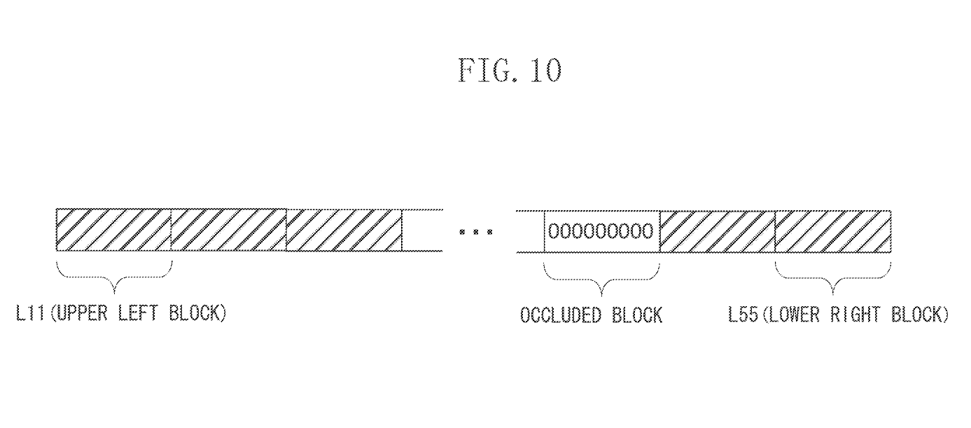

Referring back to FIG. 5, in step S580, the feature extraction unit 520 integrates the feature amounts determined for respective local blocks to generate a feature vector. FIG. 10 is a diagram illustrating the integrated feature vector in detail. In FIG. 10, a shaded portion represents a feature amount portion of the local block determined not to be an occluded area. In such a shaded portion, values of the HOG feature amount are arranged. The HOG feature amount can be, for example, 9 actual numbers. Meanwhile, in the local block determined to be an occluded area, values of “0” are arranged as 9 actual numbers as illustrated in FIG. 10, so that a dimension thereof is equal to that of the HOG feature amount. Even if the local feature amount differs from the HOG feature amount, a value of “0” may be input so that dimensions of the local feature amounts are equal. The feature vector is one vector generated by integrating these feature amounts. The feature vector has an N×D dimension, where D is a dimension of the local feature amount and N is the number of local blocks.

Referring back to FIG. 5, in step S590, the pattern collation unit 530 determines whether the partial area image is a person based on the feature vector acquired from the area excluding the occluded area determined in step S580. For example, the pattern collation unit 530 can determine whether the partial area image is a person by using a parameter that is acquired by learning performed by a support vector machine (SVM), as discussed in non-patent document 2. Herein, the parameters include a weight coefficient corresponding to each local block, and a threshold value for the determination. The pattern collation unit 530 performs product-sum calculation between the feature vector determined in step S580 and a weight coefficient in the parameters, and compares the calculation result with a threshold value to acquire an identification result of the human body. If the calculation result is the threshold value or greater, the pattern collation unit 530 outputs the operation result as a score and position coordinates indicating the partial area. The position coordinates are vertical and horizontal coordinate values of top, bottom, right, and left edges of the partial area in the input image acquired by the image acquisition unit 100. On the other hand, if the calculation result is smaller than the threshold value, the pattern collation unit 530 does not output the score or position coordinates. Then, such a detection result is stored in a memory (not illustrated) inside the pattern collation unit 530 or the storage unit 800.

The method for human body identification processing is not limited to the pattern collation using the SVM. For example, a cascade-type classifier based on adaptive boosting (AdaBoost) learning discussed in non-patent document 1 may be used.

### <Partial Area Integration Processing by Area Integration Unit>

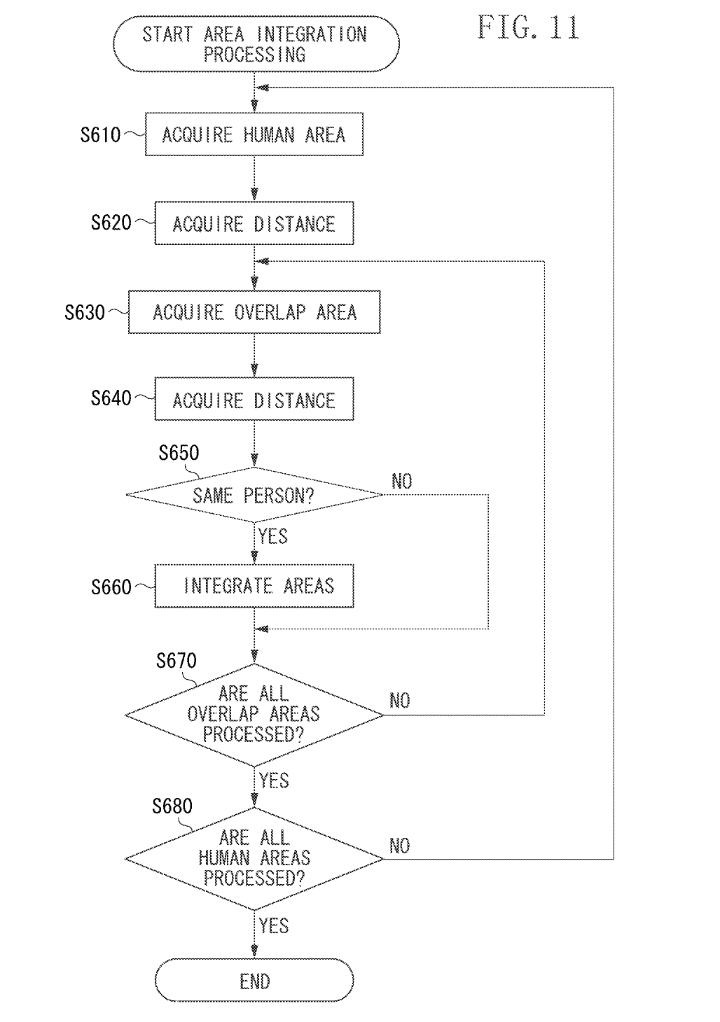

Next, partial area integration processing to be executed by the area integration unit 600 is described with reference to FIG. 11.

The area integration unit 600 executes processing for integrating overlapping detection results from a plurality of partial areas detected to include a person. In step S610, the same person determination unit 610 first acquires one detection result from a list of the detection results acquired in step S500 as a human area.

Subsequently, in step S620, the same person determination unit 610 acquires a distance of the partial area corresponding to the position coordinates of the detection result acquired in step S610 from the distance acquisition unit 300. Such acquisition of the distance can be performed similarly to the processing described in step S510 illustrated in FIG. 5.

Subsequently, in step S630, the same person determination unit 610 acquires a partial area that overlaps the detection result acquired in step S610 from the list of detection results. More specifically, the same person determination unit 610 compares the position coordinates of the detection result acquired in step S610 with position coordinates of the one partial area extracted from the list of detection results. If the two partial areas satisfy expression (3) described below, the same person determination unit 610 determines that these partial areas overlap.

k×S1>S2 (3)

In the expression (3), S1 is an area of a portion in which the two partial areas overlap, S2 is an area of a portion that belongs to only one of the two partial areas, and k is a predetermined constant. In other words, if the proportion of the overlapping portions is greater than a predetermined level, the same person determination unit 610 determines that these partial areas overlap.

In step S640, the same person determination unit 610 acquires a distance of the partial area acquired in step S630 from the distance acquisition unit 300. Such acquisition of the distance can be performed similarly to the processing performed in step S620.

In step S650, the same person determination unit 610 compares the distance of the partial area of the detection result acquired in step S620 with the distance of the overlapping partial area acquired in step S640, and determines whether the same person is detected in these two partial areas. Particularly, if expression (4) described below is satisfied, the same person determination unit 610 determines that the same person is detected.

abs(d2−d3)<dT2 (4)

where d2 and d3 are distances of the two respective overlapping partial areas.

In the expression (4), dT2 is a predetermined threshold value. For example, if a detection target is a person, dT1 may be a value corresponding to an approximate thickness of a human body. Further, in the expression (4), abs ( ) indicates absolute value calculation.

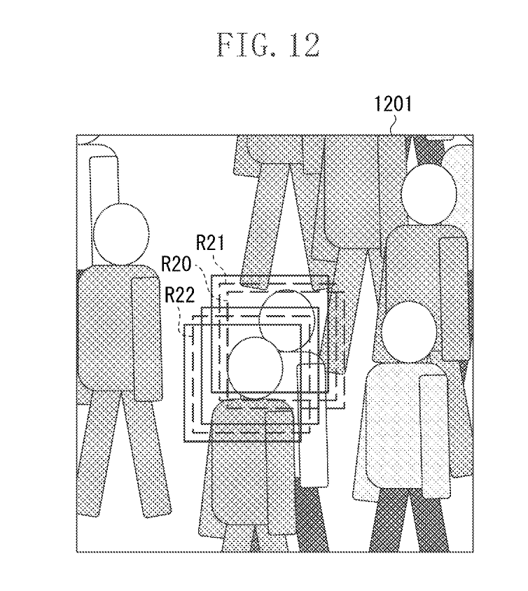

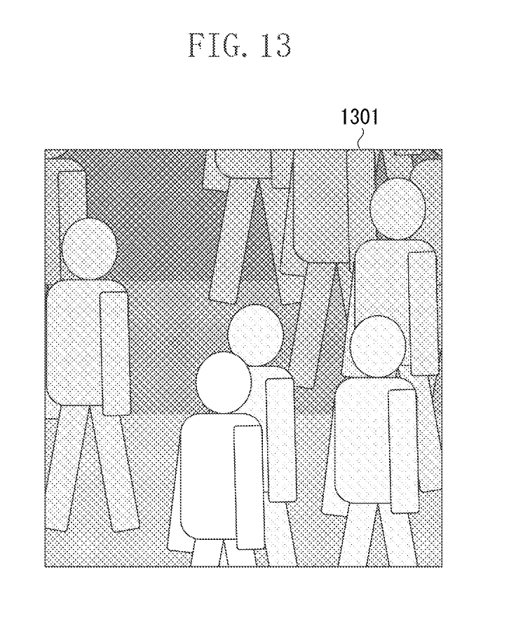

FIG. 12 is a diagram illustrating an example of a detection result near the partial area R2 illustrated in FIG. 8. FIG. 13 is a diagram illustrating an example of a depth map of a range image 1301 corresponding to FIG. 11. In the range image illustrated in FIG. 13, the higher the density, the farther the distance. The lower the density, the closer the distance.

For example, assume that rectangles R20 and R21 indicated by broken lines in FIG. 12 are the partial areas acquired in step S610 and step S630, respectively. In such a case, the same person determination unit 610 compares distances of these two partial areas, and determines whether these partial areas include the same person. By referring to the range image 1301 illustrated in FIG. 13, the same person determination unit 610 can determine that these partial areas include the same person since a distance difference is within the predetermined value according to the expression (4).

On the other hand, if a rectangle R22 indicated by broken lines in FIG. 12 is assumed to be the partial area acquired in step S630, a distance difference between the partial area of the rectangle R22 and the partial area of the rectangle R20 is greater than the predetermined value according to the expression (4). Thus, the same person determination unit 610 can determine that these areas include different persons.

In the present exemplary embodiment, a distance corresponding to a local block at a predetermined position is used as a distance of each of two overlapping partial areas. However, the present exemplary embodiment is not limited thereto. For example, a distance of each block inside the partial area may be detected, so that an average value, a median value, or a mode value thereof may be used. Alternatively, the present exemplary embodiment may use an average value of distances of local blocks determined to include a person and in which local feature amounts are calculated.

Referring back to the description of FIG. 11, if the same person determination unit 610 determines that the same person is detected in the two partial areas (YES in step S650), the processing proceeds to step S660. In step S660, the partial area integration unit 620 integrates the detection results. In the integration processing, the partial area integration unit 620 compares the scores of the two partial areas determined by the human body identification unit 500. The partial area integration unit 620 deletes a partial area having a lower score, i.e., a partial area having lower human-like characteristics, from the list of detection results. On the other hand, if the same person determination unit 610 determines that different persons are detected in the two partial areas (NO in step S650), the partial area integration processing is not performed. The integration processing is not limited to the method of deleting the partial area having a lower score from the list. For example, an average of position coordinates of the both partial areas may be calculated, and then a partial area in the average position may be set as a partial area to be used after the integration.

The processing from step S630 to step S660 is sequentially repeated (NO in step S670) with respect to all other partial areas which overlap the detection result (one partial area) acquired in step S610. Further, the processing from step S610 to step S660 is sequentially repeated (NO in step S680) with respect to all the detection results (all the partial areas included) acquired in step S500.

As described above, in the present exemplary embodiment, the object detection apparatus 10 uses a distance to estimate an occluded area in which a person is occluded by an object that overlaps a detection target person in a partial area of an input image, and calculates a local feature amount of a local area inside the partial area based on the estimation result. This enables a detection target object to be appropriately detected while suppressing an amount of calculation processing for object detection even in a crowded state.

Further, in the present exemplary embodiment, the object detection apparatus 10 uses a distance to determine whether partial areas overlapping each other include the same person or different persons. If the object detection apparatus 10 determines that the partial areas include different persons, processing for equally integrating these partial areas can be avoided. This enables human detection to be performed with good accuracy even in a crowed state.

### Modification Example

The present invention has been described using an example case in which a person is detected from an image. However, the present invention may be applicable to the case where a pattern used for collation is adapted to an object other than a person. In such a case, every object that can be captured in an image can be a detection target.

Further, the present invention has been described using an example case in which a background object occluded by a foreground object is detected, but is not limited thereto. For example, the present invention may be applicable to detection of a foreground object having an outline that is difficult to be extracted due to an overlap of a background object, by using a distance. Further, the application of the present invention may enable a detection target object to be effectively detected from a background image.

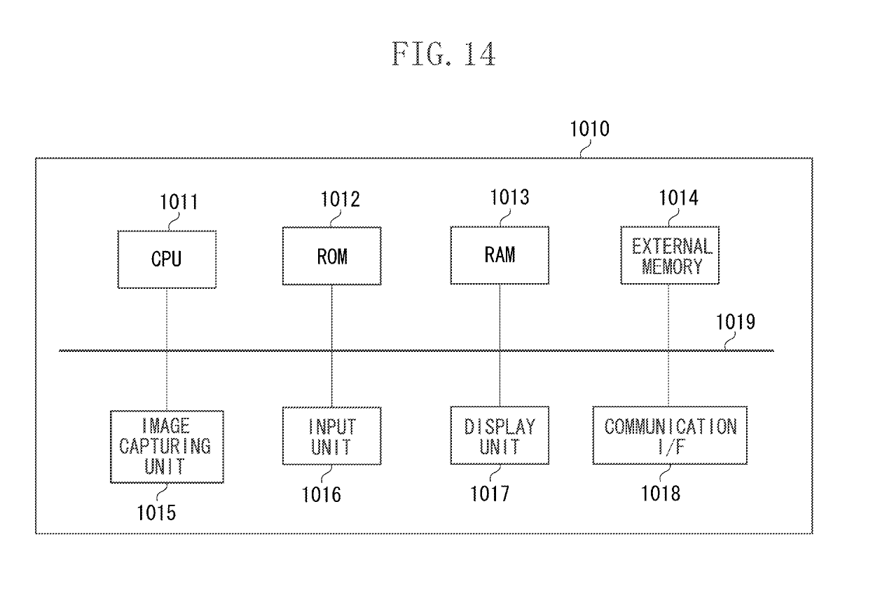

FIG. 14 is a diagram illustrating an example of a computer 1010 configuring one part or all parts of components in an object detection apparatus 10 according to the exemplary embodiments. As illustrated in FIG. 14, the computer 1010 may include a central processing unit (CPU) 1011, a read only memory (ROM) 1012, a random access memory (RAM) 1013, an external memory 1014 such as a hard disk and an optical disk, an input unit 1016, a display unit 1017, a communication interface (I/F) 1018, and a bus 1019. The CPU 1011 executes a program, and the ROM 1012 stores programs and other data. The RAM 1013 stores programs and data. The input unit 1016 inputs an operation performed by of an operator using, for example, a keyboard and a mouse, and other data. The display unit 1017 displays, for example, image data, a detection result, and a recognition result. The communication I/F 1018 communicates with an external unit. The bus 1019 connects these units. Further, the computer 1010 can include an image capturing unit 1015 for capturing an image.

According to the above-described exemplary embodiments, even if a plurality of objects overlaps in an image, the possibility that the plurality of overlapping objects is identified as the same object can be reduced, and detection failure and misdetection of an object can be suppressed. Therefore, even if an image is captured in a crowded state, an object can be detected with higher accuracy.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-233135, filed Nov. 17, 2014, which is hereby incorporated by reference herein in its entirety.

What is claimed is:

1. An object detection apparatus comprising:
an extraction unit configured to extract a plurality of partial areas from an acquired image;
a distance acquisition unit configured to acquire a distance from a viewpoint for each pixel in the extracted partial area;
an identification unit configured to identify whether the partial area includes a predetermined object;
a determination unit configured to determine, among the partial areas identified to include the predetermined object by the identification unit, whether to integrate identification results of a plurality of partial areas that overlap each other based on the distances of the pixels in the overlapping partial areas; and
an integration unit configured to integrate the identification results of the plurality of partial areas determined to be integrated, and detect a detection target object based on the integrated identification result of the plurality of partial areas.

2. The object detection apparatus according to claim 1, wherein the determination unit compares distances corresponding to the plurality of respective partial areas which overlap each other and are identified to include the predetermined object, and determines to integrate identification results of the plurality of partial areas which overlap each other if a difference between the distances is smaller than a predetermined threshold value.

3. The object detection apparatus according to claim 1, wherein the determination unit compares distances corresponding to the plurality of respective partial areas which overlap each other and are identified to include the predetermined object, and determines that objects in the plurality of partial areas which overlap each other are same if a difference between the distances is smaller than a predetermined threshold value.

4. The object detection apparatus according to claim 1, further comprising a recognition unit configured to recognize the object detected from the acquired image.

5. The object detection apparatus according to claim 1, wherein the distance is a distance in a depth direction from an image capturing apparatus that has captured the acquired image to a captured target object.

6. An object detection apparatus comprising:
an extraction unit configured to extract a plurality of partial areas from an acquired image;
a distance acquisition unit configured to acquire a distance from a viewpoint for each pixel in the extracted partial area;
a setting unit configured to set a plurality of local areas within the extracted partial area;
an estimation unit configured, based on the distance, to estimate an area including a predetermined object in the plurality of partial areas;
a calculation unit configured, based on the result estimated by the estimation unit, to calculate a local feature amount of the local area within the partial area; and
an identification unit configured, based on the calculated local feature amount, to identify whether the partial area includes the predetermined object.

7. The object detection apparatus according to claim 6, wherein the estimation unit compares a reference distance set at a position serving as a reference in the partial area with a distance acquired for the local area, and estimates that the local area includes the predetermined object if a difference between the two distances is a predetermined threshold value or smaller.

8. The object detection apparatus according to claim 6,
wherein the estimation unit, based on the distance, estimates a local area in which the predetermined object is occluded by a foreground object that overlaps the predetermined object in the partial area, and
wherein the calculation unit does not calculate the local feature amount from a local area in which the predetermined object is estimated to be occluded among the local areas within the partial area.

9. The object detection apparatus according to claim 6, wherein the calculation unit, based on the result estimated by the estimation unit, calculates a local feature amount of an outline area of a detection target object in the local area.

10. The object detection apparatus according to claim 6, further comprising:
a determination unit configured, based on the distance, to determine whether to integrate identification results of a plurality of partial areas that overlap each other among the partial areas identified to include the predetermined object by the identification unit;
an integration unit configured to integrate the identification results of the plurality of partial areas determined to be integrated; and
a detection unit configured to detect a detection target object based on the integrated identification result of the plurality of partial areas.

11. The object detection apparatus according to claim 6, wherein the identification unit generates a feature vector from the calculated local feature amount, and identifies whether the partial area includes the predetermined object by performing pattern collation of the generated feature vector with a weight coefficient that is set beforehand for each local area.

12. The object detection apparatus according to claim 6, wherein the distance is a distance in a depth direction from an image capturing apparatus that has captured the acquired image to a captured target object.

13. An object detection method comprising:
extracting a plurality of partial areas from an acquired predetermined-image;
acquiring a distance from a viewpoint for each pixel in the extracted partial area;
identifying whether the partial area includes a predetermined object;
determining, among the partial areas identified to include the predetermined object, whether to integrate identification results of a plurality of partial areas that overlap each other based on the distances of the pixels in the overlapping partial areas; and
integrating the identification results of the plurality of partial areas determined to be integrated to detect a detection target object based on the integrated identification result of the plurality of partial areas.

14. An object detection method comprising:
extracting a plurality of partial areas from an acquired predetermined-image;
acquiring a distance from a viewpoint for each pixel in the extracted partial area;
setting a plurality of local areas within the extracted partial area;
estimating, based on the distance, an area including a predetermined object in the plurality of partial areas;
calculating to extract, based on the estimated result, a local feature amount of the local area within the partial area; and
identifying, based on the calculated and extracted local feature amount, whether the partial area includes the predetermined object.

15. A storage medium storing a program for causing a computer to execute operations comprising:
extracting a plurality of partial areas from an acquired predetermined-image;
acquiring a distance from a viewpoint for each pixel in the extracted partial area; and
identifying whether the partial area includes a predetermined object;
determining, among the partial areas identified to include the predetermined object, whether to integrate identification results of a plurality of partial areas that overlap each other based on the distances of the pixels in the overlapping partial areas; and
integrating the identification results of the plurality of partial areas determined to be integrated to detect a detection target object based on the integrated identification result of the plurality of partial areas.

16. A storage medium storing a program for causing a computer to execute operations comprising:
extracting a plurality of partial areas from an acquired predetermined-image;
acquiring a distance from a viewpoint for each pixel in the extracted partial area;
setting a plurality of local areas within the extracted partial area;
estimating, based on the distance, an area including a predetermined object in the plurality of partial areas;
calculating to extract, based on the estimated result, a local feature amount of the local area within the partial area; and
identifying, based on the calculated and extracted local feature amount, whether the partial area includes the predetermined object.
